(19) United States
(12) Patent Application Publication
(10) Pub. No.: US 2025/0383150 A1
(43) Pub. Date: Dec. 18, 2025

(54) HEAT TREATMENT APPARATUS AND ELECTRONIC DEVICE

(71) Applicant: Samsung Display Co., Ltd., Yongin-Si (KR)

(72) Inventor: Taek Geun LEE, Yongin-si (KR)

(21) Appl. No.: 19/030,762

(22) Filed: Jan. 17, 2025

(30) Foreign Application Priority Data
Jun. 13, 2024 (KR) 10-2024-0077109

(51) Int. Cl. F26B 23/10; F26B 21/02

(52) U.S. Cl. CPC F26B 23/10; F26B 21/02

(57) ABSTRACT

A heat treatment apparatus is disclosed that includes a chamber, an injection nozzle array, and a discharge nozzle array. The chamber includes an injection surface and a discharge surface and provides an accommodation space to accommodate a heat treatment object. The injection nozzle array is connected to the accommodation space through the injection surface and includes a plurality of injection nozzles arranged along row and column directions. The discharge nozzle array is connected to the accommodation space through the discharge surface and includes a plurality of discharge nozzles arranged along the row and column directions. A plurality of additional discharge nozzles are connected to the accommodation space through the discharge surface, disposed above the plurality of discharge nozzles, and arranged along the row direction. The number of the injection nozzles is less than a sum of the number of the discharge nozzles and the number of the additional discharge nozzles.

### CROSS-REFERENCE TO RELATED APPLICATION

This application claims priority to and the benefit of Korean Patent Application No. 10-2024-0077109 filed in the Korean Intellectual Property Office on Jun. 13, 2024, the entire contents of which are incorporated herein by reference.

### BACKGROUND OF THE INVENTION

### (a) Field of the Invention

The present disclosure relates to a heat treatment apparatus and an electronic device.

### (b) Description of the Related Art

The heat treatment apparatus is an apparatus for performing heat treatment on a heat treatment object. The heat treatment apparatus includes a chamber for providing an accommodation space for accommodating a heat treatment object, injection nozzles for providing an injection gas into the accommodation space, and discharge nozzles for discharging gas within the accommodation space.

When the gas in the accommodation space is not smoothly discharged, the gas may stick (e.g., form a film) and cause a defect in the heat treatment apparatus.

### SUMMARY

The present disclosure provides a heat treatment apparatus that may prevent gas from sticking or forming a film.

An embodiment of a heat treatment apparatus includes: a chamber including an injection surface and a discharge surface facing the injection surface and providing an accommodation space to accommodate a heat treatment object; an injection nozzle array connected to the accommodation space through the injection surface and including a plurality of injection nozzles arranged along row and column directions; a discharge nozzle array connected to the accommodation space through the discharge surface and including a plurality of discharge nozzles arranged along the row and column directions; and a plurality of first additional discharge nozzles connected to the accommodation space through the discharge surface, disposed above the plurality of discharge nozzles, and arranged along the row direction. The number of the plurality of injection nozzles is less than a sum of the number of the plurality of discharge nozzles and the number of the plurality of first additional discharge nozzles.

The injection nozzle array may include first to N-th (N is a natural number of 3 or more) injection nozzle rows arranged along the column direction, and the discharge nozzle array may include first to N-th discharge nozzle rows arranged along the column direction.

An M-th (M is a natural number of 1 or more and N or less) injection nozzle row among the first to N-th injection nozzle rows may be disposed at the same height as an M-th discharge nozzle row among the first to N-th discharge nozzle rows.

The heat treatment apparatus may further include a plurality of second additional discharge nozzles connected to the accommodation space through the discharge surface, disposed between the N-th discharge nozzle row and the (N−1)-th discharge nozzle row, and arranged along the row direction.

The number of the plurality of injection nozzles may be the same as the number of the plurality of discharge nozzles.

The heat treatment apparatus may further include a heater connected to the plurality of injection nozzles and heating an injection gas provided to the plurality of injection nozzles.

The heat treatment apparatus may further include a heating unit surrounding at least one of the plurality of injection nozzles, the plurality of discharge nozzles, and the plurality of first additional discharge nozzles.

An embodiment of a heat treatment apparatus includes: a chamber including an injection surface and a discharge surface facing the injection surface and providing an accommodation space to accommodate a heat treatment object; an injection nozzle array connected to the accommodation space through the injection surface and including a plurality of injection nozzles arranged along row and column directions; and a discharge nozzle array connected to the accommodation space through the discharge surface and including a plurality of discharge nozzles arranged along the row and column directions. An inner diameter of each of the discharge nozzles disposed in an uppermost row among the plurality of discharge nozzles is greater than an inner diameter of each of the discharge nozzles disposed in a lowermost row among the plurality of discharge nozzles.

The number of the plurality of injection nozzles may be the same as the number of the plurality of discharge nozzles.

The injection nozzle array may include first to N-th (N is a natural number of 3 or more) injection nozzle rows arranged along the column direction, and the discharge nozzle array may include first to N-th discharge nozzle rows arranged along the column direction.

An M-th (M is a natural number of 1 or more and N or less) injection nozzle row among the first to N-th injection nozzle rows may be disposed at the same height as an M-th discharge nozzle row among the first to N-th discharge nozzle rows.

An inner diameter of each of the discharge nozzles defining the N-th discharge nozzle row may be greater than an inner diameter of each of the injection nozzles defining the N-th injection nozzle row.

An inner diameter of each of the discharge nozzles defining the (N−1)-th discharge nozzle row may be greater than an inner diameter of each of the injection nozzles defining the (N−1)-th injection nozzle row.

An inner diameter of each of the discharge nozzles defining the N-th discharge nozzle row may be greater than an inner diameter of each of the discharge nozzles defining the (N−1)-th discharge nozzle row.

An inner diameter of each of the discharge nozzles defining the first discharge nozzle row may be the same as an inner diameter of each of the injection nozzles defining the first injection nozzle row.

An embodiment of a heat treatment apparatus includes: a chamber including an injection surface and a discharge surface facing the injection surface and providing an accommodation space to accommodate a heat treatment object; an injection nozzle array connected to the accommodation space through the injection surface and including a plurality of injection nozzles arranged along row and column directions; and a discharge nozzle array connected to the accommodation space through the discharge surface and including a plurality of discharge nozzles arranged along the row and column directions. The number of discharge nozzles disposed in an uppermost row among the plurality of discharge nozzles may be greater than the number of discharge nozzles disposed in a lowermost row among the plurality of discharge nozzles.

The injection nozzle array may include first to N-th (N is a natural number of 3 or more) injection nozzle rows arranged along the column direction, and the discharge nozzle array may include first to N-th discharge nozzle rows arranged along the column direction.

An M-th (M is a natural number of 1 or more and N or less) injection nozzle row among the first to N-th injection nozzle rows may be disposed at the same height as an M-th discharge nozzle row among the first to N-th discharge nozzle rows.

The number of discharge nozzles defining the N-th discharge nozzle row may be greater than the number of injection nozzles defining the N-th injection nozzle row.

The number of discharge nozzles defining the (N−1)-th discharge nozzle row may be greater than the number of injection nozzles defining the (N−1)-th injection nozzle row.

An embodiment of an electronic device includes: a processor to provide input image data; and a display device to display an image based on the input image data. The display device may include a window. The window may be a heat treatment object which is heat treated by using the heat treatment apparatus according to the embodiments of the present disclosure.

According to the heat treatment apparatus according to the embodiments of the present disclosure, additional discharge nozzles may be provided at the upper portion of the discharge surface, the inner diameters of the discharge nozzles may be relatively large, or the number of discharge nozzles may be relatively large. Accordingly, the gas mainly distributed in the upper portion of the accommodation space, which is at a relatively high temperature, may be discharged more smoothly. Therefore, it is possible to prevent defects from occurring in the heat treatment apparatus due to gas sticking.

### BRIEF DESCRIPTION OF THE DRAWINGS

FIG. 1 illustrates a heat treatment apparatus according to an embodiment of the present disclosure.

FIG. 2 illustrates a plan view of an embodiment of a plurality of injection nozzles of the heat treatment apparatus of FIG. 1.

FIG. 3 illustrates a plan view of an embodiment of a plurality of discharge nozzles and a plurality of additional discharge nozzles of the heat treatment apparatus of FIG. 1.

FIG. 4 illustrates an embodiment of a heating unit.

FIG. 5 illustrates a heat treatment apparatus according to an embodiment of the present disclosure.

FIG. 6 illustrates a plan view of an embodiment of a plurality of injection nozzles of the heat treatment apparatus of FIG. 5.

FIG. 7 illustrates a plan view of an embodiment of a plurality of discharge nozzles of the heat treatment apparatus of FIG. 5.

FIG. 8 illustrates a heat treatment apparatus according to an embodiment of the present disclosure.

FIG. 9 illustrates a plan view of an embodiment of a plurality of injection nozzles of the heat treatment apparatus of FIG. 8.

FIG. 10 illustrates a plan view of an embodiment of a plurality of discharge nozzles of the heat treatment apparatus of FIG. 8.

FIG. 11 illustrates a schematic block diagram of an electronic device including a display device.

FIG. 12 illustrates a schematic diagram of an example where the electronic device of FIG. 11 is a smartphone.

FIG. 13 illustrates a schematic diagram of an example where the electronic device of FIG. 11 is a tablet computer.

### DETAILED DESCRIPTION OF THE EMBODIMENTS

Hereinafter, example embodiments of the present disclosure will be described in detail with reference to the accompanying drawings. The following description is intended to provide only a sufficient disclosure to enable the understanding of the operation of the invention, and any other disclosure is omitted to avoid obscuring the scope of the invention. In addition, the inventive concept may be embodied in different forms and is not limited to the embodiments set forth herein. The embodiments described herein are provided for the purpose of describing the technical concept of the invention in sufficient detail for those skilled in the art to easily practice it.

Throughout the specification, when it is described that an element is “connected” to another element, this includes not only being “directly connected”, but also being “indirectly connected” with another device therebetween. The terms used herein are for the purpose of describing specific embodiments and are not intended to limit the scope of the invention. Throughout the specification, unless explicitly described to the contrary, the words “comprise” and “includes” (as well as variations such as “comprises” and “comprising”) will be understood to imply the inclusion of stated elements but not the exclusion of any other elements. For the purposes of this disclosure, “at least one of X, Y, and Z” and “at least one selected from the array consisting of X, Y, and Z” may be construed as X only, Y only, Z only, or any combination of two or more of X, Y, and Z, such as, for instance, XYZ, XYY, YZ, and ZZ. As used herein, the word “or” means logical “or” so that, unless the context indicates otherwise, the expression “A, B, or C” means “A and B and C,” “A and B but not C,” “A and C but not B,” “B and C but not A,” “A but not B and not C,” “B but not A and not C,” and “C but not A and not B.”

Although the terms first, second, etc. may be used herein to describe various constituent elements, these constituent elements should not be limited by these terms. These terms are used to distinguish one constituent element from another. Thus, a first constituent element discussed below could be termed a second constituent element without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (for example, rotated 90 degrees or at other orientations), and, as such, the spatially relative descriptors used herein interpreted accordingly.

Various embodiments are described herein with reference to sectional illustrations that are schematic illustrations of idealized embodiments. As such, variations from the shapes of the illustrations as a result, for example, of manufacturing techniques or tolerances, are to be expected. Thus, exemplary embodiments disclosed herein should not be construed as limited to the particular illustrated shapes of regions, but are to include deviations in shapes that result from, for instance, manufacturing. Thus, the regions illustrated in the drawings are schematic in nature and their shapes are not intended to illustrate the actual shape of a region of a device and are not intended to be limiting.

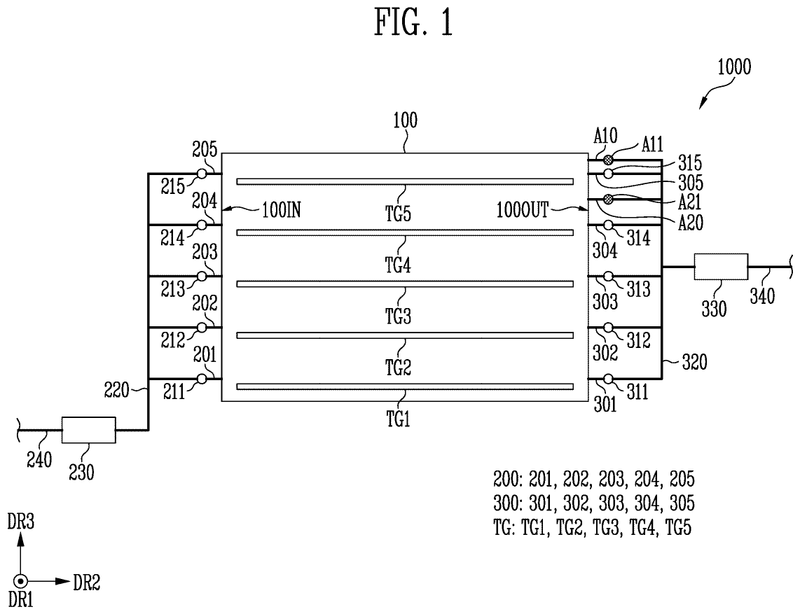

FIG. 1 illustrates a heat treatment apparatus according to an embodiment of the present disclosure.

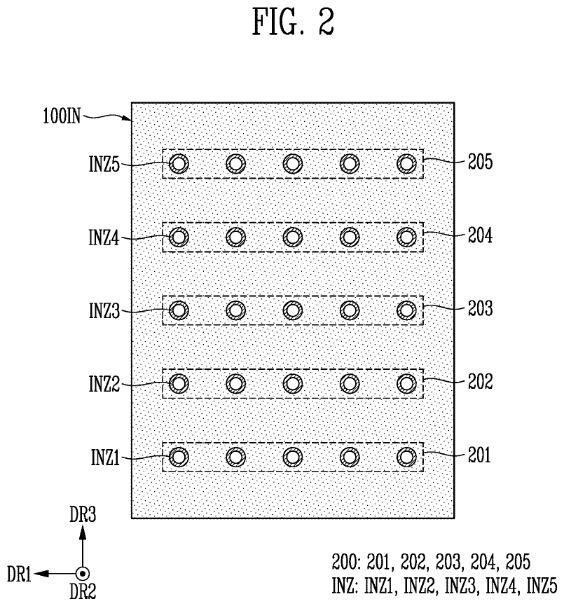

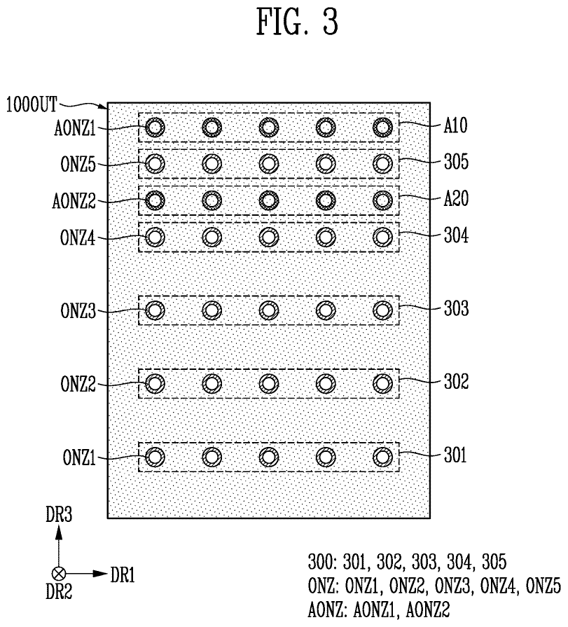

Referring to FIG. 1, a heat treatment apparatus 1000 may include a chamber 100, an injection nozzle array 200 including a plurality of injection nozzles (INZ in FIG. 2), a discharge nozzle array 300 including a plurality of discharge nozzles (ONZ in FIG. 3), and a plurality of additional discharge nozzles (AONZ in FIG. 3).

The chamber 100 may provide an accommodation space for accommodating a heat treatment object TG. The heat treatment object TG may be, for example, glass configuring a window of a display device. In the embodiment, the heat treatment object TG may include first to N-th heat treatment objects arranged to be spaced apart from each other along a third direction DR3. Here, N may be a natural number of 3 or more. Hereinafter, N is defined to refer to a natural number of 3 or more. For example, the heat treatment object TG may include first to fifth heat treatment objects TG1, TG2, TG3, TG4, and TG5.

The chamber 100 may include an injection surface 100IN and an discharge surface 100OUT facing the injection surface 100IN. The injection surface 100IN may be substantially parallel to a plane defined in the third direction DR3 and a first direction DR1 perpendicular to the third direction DR3. The discharge surface 100OUT may be substantially parallel to the injection surface 100IN. The injection surface 100IN and the discharge surface 100OUT may be spaced apart from each other in a second direction DR2 perpendicular to the first and third directions DR1 and DR3. The injection surface 100IN and the discharge surface 100OUT may surround a portion of the accommodation space.

The plurality of injection nozzles (INZ in FIG. 2) configuring the injection nozzle array 200 may be connected to the accommodation space through the injection surface 100IN. An injection gas may be provided to the accommodation space through the plurality of injection nozzles (INZ in FIG. 2). By heating the injection gas, heat treatment of the heat treatment object TG in the accommodation space may be performed.

The plurality of injection nozzles (INZ in FIG. 2) may be arranged along a row direction and a column direction. Here, the row direction may be the first direction DR1, and the column direction may be the third direction DR3. Hereinafter, the row direction will be referred to as the first direction DR1, and the column direction will be referred to as a third direction DR3.

In the embodiment, the injection nozzle array 200 may include first to N-th injection nozzle rows arranged along the third direction DR3. Hereinafter, an embodiment in which Nis 5 will be described for clear and concise description. However, the present disclosure is not limited thereto, and N may be 3 or a natural number of 6 or more.

The injection nozzle array 200 may include first to fifth injection nozzle rows 201, 202, 203, 204, and 205. The first to fifth injection nozzle rows 201, 202, 203, 204, and 205 may be arranged in the third direction DR3. Each of the first to fifth injection nozzle rows 201, 202, 203, 204, and 205 may include one or more injection nozzles arranged along the first direction DR1 and spaced apart from each other.

One end of the injection nozzles (INZ1 in FIG. 2) defining the first injection nozzle row 201 may be connected to the accommodation space through the injection surface 100IN, and the other end thereof may be connected to a first injection connection portion 211. The first injection connection portion 211 may have a tubular shape extending along the first direction DR1.

One end of the injection nozzles (INZ2 in FIG. 2) defining the second injection nozzle row 202 may be connected to the accommodation space through the injection surface 100IN, and the other end thereof may be connected to a second injection connection portion 212. The second injection connection portion 212 may have a tubular shape extending along the first direction DR1.

One end of the injection nozzles (INZ3 in FIG. 2) defining the third injection nozzle row 203 may be connected to the accommodation space through the injection surface 100IN, and the other end thereof may be connected to a third injection connection portion 213. The third injection connection portion 213 may have a tubular shape extending along the first direction DR1.

One end of the injection nozzles (INZ4 in FIG. 2) defining the fourth injection nozzle row 204 may be connected to the accommodation space through the injection surface 100IN, and the other end thereof may be connected to a fourth injection connection portion 214. The fourth injection connection portion 214 may have a tubular shape extending along the first direction DR1.

One end of the injection nozzles (INZ5 in FIG. 2) defining the fifth injection nozzle row 205 may be connected to the accommodation space through the injection surface 100IN, and the other end thereof may be connected to a fifth injection connection portion 215. The fifth injection connection portion 215 may have a tubular shape extending along the first direction DR1.

The first to fifth injection connection portions 211, 212, 213, 214, and 215 may be connected to a heater 230 through a first injection connection pipe 220. The heater 230 may be connected to a second injection connection pipe 240. The injection gas provided from the second injection connection pipe 240 may be heated by the heater 230 to be provided to the first injection connection pipe 220. The injection gas provided to the first injection connection pipe 220 may be provided to the accommodation space through the first to fifth injection connection portions 211, 212, 213, 214, and 215 and the plurality of injection nozzles (INZ in FIG. 2).

Here, the heater 230 may serve to prevent the injection gas from solidifying within the first to fifth injection connection portions 211, 212, 213, 214, and 215 and the plurality of injection nozzles (INZ in FIG. 2) by heating the injection gas.

The plurality of discharge nozzles (ONZ in FIG. 3) configuring the discharge nozzle array 300 may be connected to the accommodation space through the discharge surface 100OUT. The gas within the accommodation space may be discharged through the plurality of discharge nozzles (ONZ in FIG. 3). The plurality of discharge nozzles (ONZ in FIG. 3) may be arranged along the first and third directions DR1 and DR3.

In the embodiment, the discharge nozzle array 300 may include first to N-th discharge nozzle rows arranged along the third direction DR3. For example, the discharge nozzle array 300 may include first to fifth discharge nozzle rows 301, 302, 303, 304, and 305. The first to fifth discharge nozzle rows 301, 302, 303, 304, and 305 may be arranged in the third direction DR3. Each of the first to fifth discharge nozzle rows 301, 302, 303, 304, and 305 may include one or more discharge nozzles arranged along the first direction DR1 and spaced apart from each other.

One end of the discharge nozzles (ONZ1 in FIG. 3) defining the first discharge nozzle row 301 may be connected to the accommodation space through the discharge surface 100OUT, and the other end thereof may be connected to a first discharge connection portion 311. The first discharge connection portion 311 may have a tubular shape extending along the first direction DR1.

One end of the discharge nozzles (ONZ2 in FIG. 3) defining the second discharge nozzle row 302 may be connected to the accommodation space through the discharge surface 100OUT, and the other end thereof may be connected to a second discharge connection portion 312. The second discharge connection portion 312 may have a tubular shape extending along the first direction DR1.

One end of the discharge nozzles (ONZ3 in FIG. 3) defining the third discharge nozzle row 303 may be connected to the accommodation space through the discharge surface 100OUT, and the other end thereof may be connected to a third discharge connection portion 313. The third discharge connection portion 313 may have a tubular shape extending along the first direction DR1.

One end of the discharge nozzles (ONZ4 in FIG. 3) defining the fourth discharge nozzle row 304 may be connected to the accommodation space through the discharge surface 100OUT, and the other end thereof may be connected to a fourth discharge connection portion 314. The fourth discharge connection portion 314 may have a tubular shape extending along the first direction DR1.

One end of the discharge nozzles (ONZ5 in FIG. 3) defining the fifth discharge nozzle row 305 may be connected to the accommodation space through the discharge surface 100OUT, and the other end thereof may be connected to a fifth discharge connection portion 315. The fifth discharge connection portion 315 may have a tubular shape extending along the first direction DR1.

The plurality of additional discharge nozzles (AONZ in FIG. 3) may be connected to the accommodation space through the discharge surface 100OUT. The gas within the accommodation space may be discharged through the plurality of additional discharge nozzles (AONZ in FIG. 3).

In the embodiment, the plurality of additional discharge nozzles (AONZ in FIG. 3) may include first additional discharge nozzles (AONZ1 in FIG. 3) defining a first additional discharge nozzle row A10 and second additional discharge nozzles (AONZ2 in FIG. 3) defining a second additional discharge nozzle row A20. The first additional discharge nozzles (AONZ1 in FIG. 3) may be arranged along the first direction DR1. The second additional discharge nozzles (AONZ2 in FIG. 3) may be arranged along the first direction DR1.

In the embodiment, the first additional discharge nozzle row A10 may be disposed above the fifth discharge nozzle row 305, which is disposed at the uppermost portion among the first to fifth discharge nozzle rows 301, 302, 303, 304, and 305.

In the embodiment, the second additional discharge nozzle row A20 may be disposed between the fifth discharge nozzle row 305 disposed at the uppermost portion among the first to fifth discharge nozzle rows 301, 302, 303, 304, and 305, and the fourth discharge nozzle row 304 disposed thereunder.

One end of the first additional discharge nozzles (AONZ1 in FIG. 3) defining the first additional discharge nozzle row A10 may be connected to the accommodation space through the discharge surface 100OUT, and the other end thereof may be connected to a first additional discharge connection portion A11. The first additional discharge connection portion A11 may have a tubular shape extending along the first direction DR1.

One end of the second additional discharge nozzles (AONZ2 in FIG. 3) defining the second additional discharge nozzle row A20 may be connected to the accommodation space through the discharge surface 100OUT, and the other end thereof may be connected to a second additional discharge connection portion A21. The second additional discharge connection portion A21 may have a tubular shape extending along the first direction DR1.

The first to fifth discharge connection portions 311, 312, 313, 314, and 315 and the first and second additional discharge connection portions A11 and A21 may be connected to a suction portion 330 through a first discharge connection pipe 320. The suction portion 330 may be connected to a second discharge connection pipe 340. The suction portion 330 may serve to provide a suction force for gas. By the suction portion 330, the gas in the accommodation space may be discharged to the second discharge connection pipe 340 through the first to fifth discharge connection portions 311, 312, 313, 314, and 315, the first and second additional discharge connection portions A11 and A21, and the first discharge connection pipe 320.

FIG. 2 illustrates a plan view of an embodiment of a plurality of injection nozzles of the heat treatment apparatus of FIG. 1.

Referring to FIG. 1 and FIG. 2, the plurality of injection nozzles INZ may include a plurality of first injection nozzles INZ1, a plurality of second injection nozzles INZ2, a plurality of third injection nozzles INZ3, a plurality of fourth injection nozzles INZ4, and a plurality of fifth injection nozzles INZ5.

The plurality of first injection nozzles INZ1 may be arranged along the first direction DR1. The plurality of first injection nozzles INZ1 may define the first injection nozzle row 201.

The plurality of second injection nozzles INZ2 may be arranged along the first direction DR1. The plurality of second injection nozzles INZ2 may define the second injection nozzle row 202. The second injection nozzle row 202 may be disposed above the first injection nozzle row 201.

The plurality of third injection nozzles INZ3 may be arranged along the first direction DR1. The plurality of third injection nozzles INZ3 may define the third injection nozzle row 203. The third injection nozzle row 203 may be disposed above the second injection nozzle row 202.

The plurality of fourth injection nozzles INZ4 may be arranged along the first direction DR1. The plurality of fourth injection nozzles INZ4 may define the fourth injection nozzle row 204. The fourth injection nozzle row 204 may be disposed above the third injection nozzle row 203.

The plurality of fifth injection nozzles INZ5 may be arranged along the first direction DR1. The plurality of fifth injection nozzles INZ5 may define the fifth injection nozzle row 205. The fifth injection nozzle row 205 may be disposed above the fourth injection nozzle row 204.

In the embodiment, the number of injection nozzles defining each of the first to fifth injection nozzle rows 201, 202, 203, 204, and 205 may be the same. For example, five first to fifth injection nozzles INZ1, INZ2, INZ3, INZ4, and INZ5 may be provided, respectively.

In the embodiment, the plurality of injection nozzles INZ may have substantially the same inner diameter.

FIG. 3 illustrates a plan view of an embodiment of a plurality of discharge nozzles and a plurality of additional discharge nozzles of the heat treatment apparatus of FIG. 1.

Referring to FIG. 1 and FIG. 3, the plurality of discharge nozzles ONZ may include a plurality of first discharge nozzles ONZ1, a plurality of second discharge nozzles ONZ2, a plurality of third discharge nozzles ONZ3, a plurality of fourth discharge nozzles ONZ4, and a plurality of fifth discharge nozzles ONZ5.

The plurality of first discharge nozzles ONZ1 may be arranged along the first direction DR1. The plurality of first discharge nozzles ONZ1 may define the first discharge nozzle row 301. In the embodiment, the first discharge nozzle row 301 may be disposed at the same height as the first injection nozzle row 201.

The plurality of second discharge nozzles ONZ2 may be arranged along the first direction DR1. The plurality of second discharge nozzles ONZ2 may define the second discharge nozzle row 302. The second discharge nozzle row 302 may be disposed above the first discharge nozzle row 301. In the embodiment, the second discharge nozzle row 302 may be disposed at the same height as the second injection nozzle row 202.

The plurality of third discharge nozzles ONZ3 may be arranged along the first direction DR1. The plurality of third discharge nozzles ONZ3 may define the third discharge nozzle row 303. The third discharge nozzle row 303 may be disposed above the second discharge nozzle row 302. In the embodiment, the third discharge nozzle row 303 may be disposed at the same height as the third injection nozzle row 203.

The plurality of fourth discharge nozzles ONZ4 may be arranged along the first direction DR1. The plurality of fourth discharge nozzles ONZ4 may define the fourth discharge nozzle row 304. The fourth discharge nozzle row 304 may be disposed above the third discharge nozzle row 303. In the embodiment, the fourth discharge nozzle row 304 may be disposed at the same height as the fourth injection nozzle row 204.

The plurality of fifth discharge nozzles ONZ5 may be arranged along the first direction DR1. The plurality of fifth discharge nozzles ONZ5 may define the fifth discharge nozzle row 305. The fifth discharge nozzle row 305 may be disposed above the fourth discharge nozzle row 304. In the embodiment, the fifth discharge nozzle row 305 may be disposed at the same height as the fifth injection nozzle row 205.

In the embodiment, the number of discharge nozzles defining each of the first to fifth discharge nozzle rows 301, 302, 303, 304, and 305 may be the same. For example, five first to fifth discharge nozzles ONZ1, ONZ2, ONZ3, ONZ4, and ONZ5 may be provided, respectively.

In the embodiment, the number of the plurality of discharge nozzles ONZ may be the same as the number of the plurality of injection nozzles (INZ in FIG. 2). For example, 25 discharge nozzles ONZ and 25 injection nozzles (INZ in FIG. 2) may be provided, respectively.

The plurality of additional discharge nozzles AONZ may include a plurality of first additional discharge nozzles AONZ1 and a plurality of second additional discharge nozzles AONZ2.

The plurality of first additional discharge nozzles AONZ1 may be arranged along the first direction DR1. The plurality of first additional discharge nozzles AONZ1 may define the first additional discharge nozzle row A10. The first additional discharge nozzle row A10 may be disposed above the fifth discharge nozzle row 305.

The plurality of second additional discharge nozzles AONZ2 may be arranged along the first direction DR1. The plurality of second additional discharge nozzles AONZ2 may define the second additional discharge nozzle row A20. The second additional discharge nozzle row A20 may be disposed between the fifth discharge nozzle row 305 and the fourth discharge nozzle row 304.

Referring to FIG. 2 and FIG. 3, the number of the plurality of injection nozzles INZ may be less than the sum of the number of the plurality of discharge nozzles ONZ and the number of the plurality of first additional discharge nozzles AONZ1. That is, the number of nozzles provided on the discharge surface 100OUT may be greater than the number of nozzles provided on the injection surface 100IN. In this case, the plurality of first additional discharge nozzles AONZ1 may be disposed at the uppermost end of the discharge surface 100OUT.

By-products (for example, gas) may be generated due to a relatively high temperature within the accommodation space of the chamber (100 in FIG. 1). These by-products may be mainly distributed in the upper portion of the accommodation space. In the present disclosure, by providing the plurality of first additional discharge nozzles AONZ1 described above, it is possible to more easily discharge by-products distributed in the upper portion of the accommodation space.

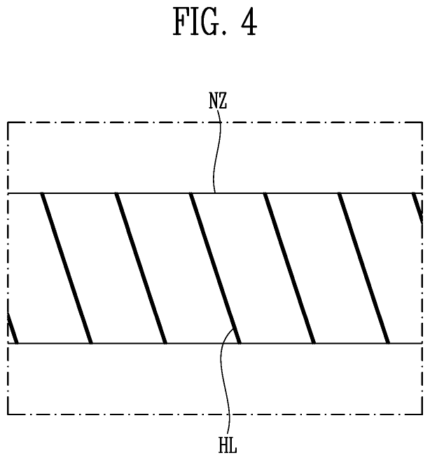

FIG. 4 illustrates an embodiment of a heating unit.

Referring to FIG. 4, at least one of the plurality of injection nozzles INZ, the plurality of discharge nozzles ONZ, and the plurality of additional discharge nozzles AONZ included in the heat treatment apparatus 1000 described with reference to FIG. 1 to FIG. 3 may be provided with a heating unit for preventing by-products (for example, gas) from sticking.

In the embodiment, the heating unit may include a heating wire HL surrounding a nozzle NZ. The heating wire HL may generate heat. The heating wire HL may heat the nozzle NZ (that is, the plurality of injection nozzles INZ, the plurality of discharge nozzles ONZ, or the plurality of additional discharge nozzles AONZ) surrounded thereby. In this case, the temperature of the nozzle NZ surrounded by the heating wire HL increases, thereby preventing by-products (for example, gas) from solidifying inside the nozzle NZ.

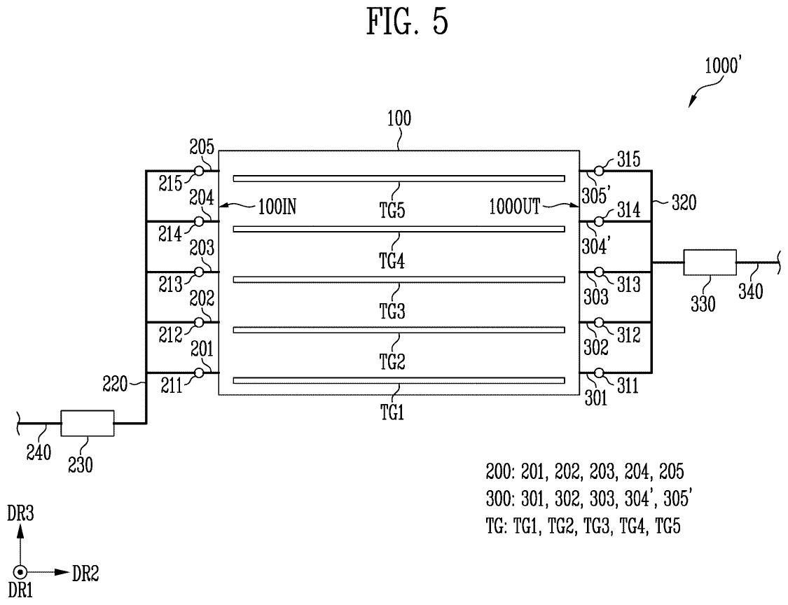

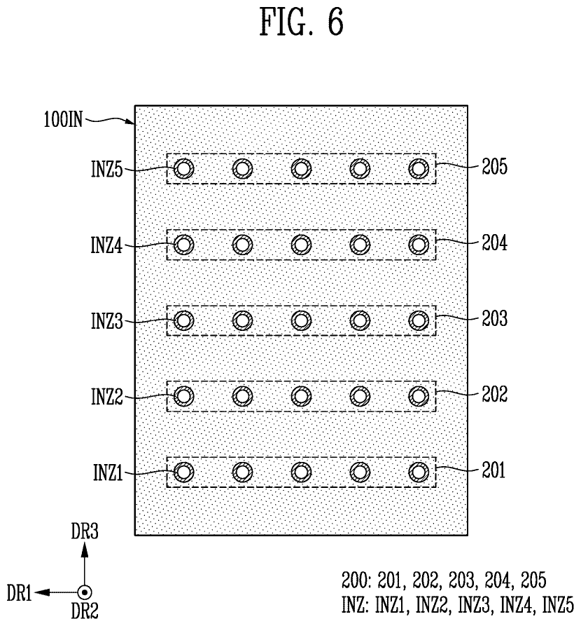

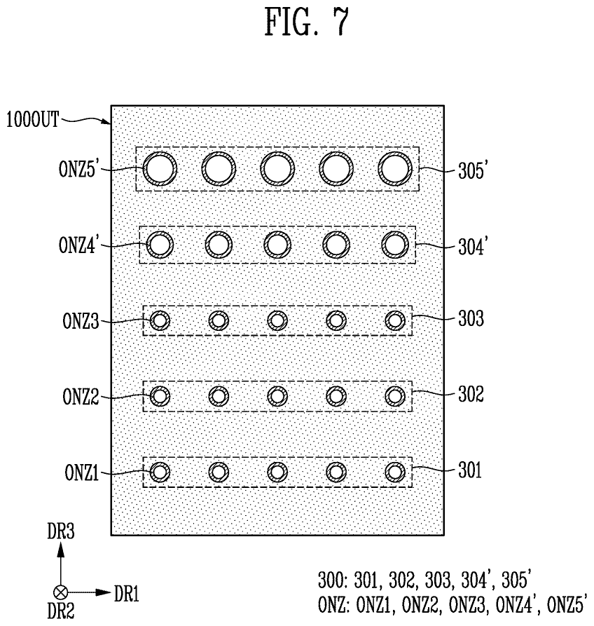

FIG. 5 illustrates a heat treatment apparatus according to an embodiment of the present disclosure. FIG. 6 illustrates a plan view of an embodiment of a plurality of injection nozzles of the heat treatment apparatus of FIG. 5. FIG. 7 illustrates a plan view of an embodiment of a plurality of discharge nozzles of the heat treatment apparatus of FIG. 5.

Referring to FIG. 5 to FIG. 7, a heat treatment apparatus 1000′ may be provided. Hereinafter, in describing the heat treatment apparatus 1000′, differences from the heat treatment apparatus 1000 described with reference to FIG. 1 to FIG. 4 will be mainly described, and any omitted description will be found in the previous description.

Compared to the heat treatment apparatus 1000, the heat treatment apparatus 1000′ may not include a plurality of additional discharge nozzles AONZ. In this case, in order to facilitate gas discharge from the upper portion of the accommodation space of the chamber portion 100 of the heat treatment apparatus 1000′, the inner diameter of each of the fifth discharge nozzles ONZ5′ defining the fifth discharge nozzle row 305′ disposed at the uppermost portion may be formed relatively large. More specifically, the inner diameter of each of the fifth discharge nozzles ONZ5′ defining the fifth discharge nozzle row 305′ disposed in the uppermost row may be greater than the inner diameter of each of the first discharge nozzles ONZ1 defining the first discharge nozzle row 301 disposed in the lowermost row.

In the embodiment, the inner diameter of each of the fifth discharge nozzles ONZ5′ defining the fifth discharge nozzle row 305′ may be greater than the inner diameter of each of the fifth injection nozzles INZ5 defining the fifth injection nozzle row 205.

In the embodiment, the inner diameter of each of the fourth discharge nozzles ONZ4′ defining the fourth discharge nozzle row 304′ may be formed to be relatively large. For example, the inner diameter of each of the fourth discharge nozzles ONZ4′ may be greater than the inner diameter of each of the fourth injection nozzles INZ4 defining the fourth injection nozzle row 204. In this case, the inner diameter of each of the fourth discharge nozzles ONZ4′ may be smaller than the inner diameter of each of the fifth discharge nozzles ONZ5′.

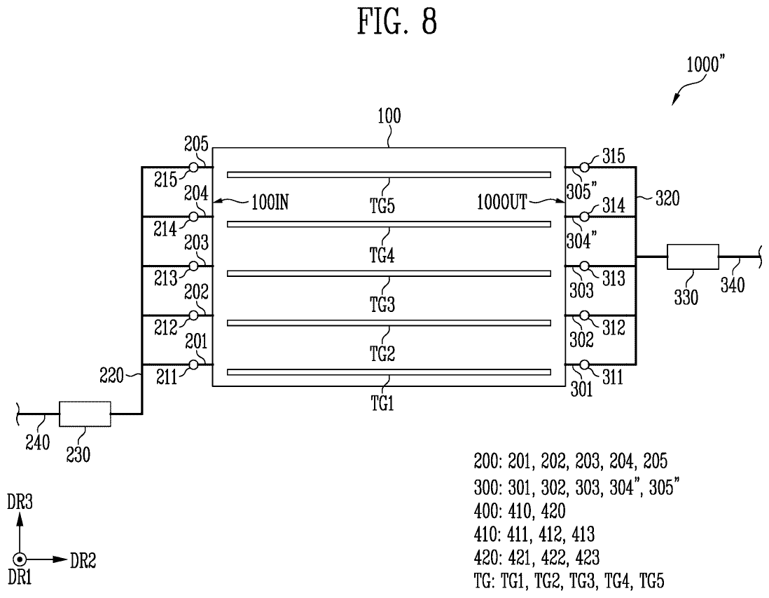

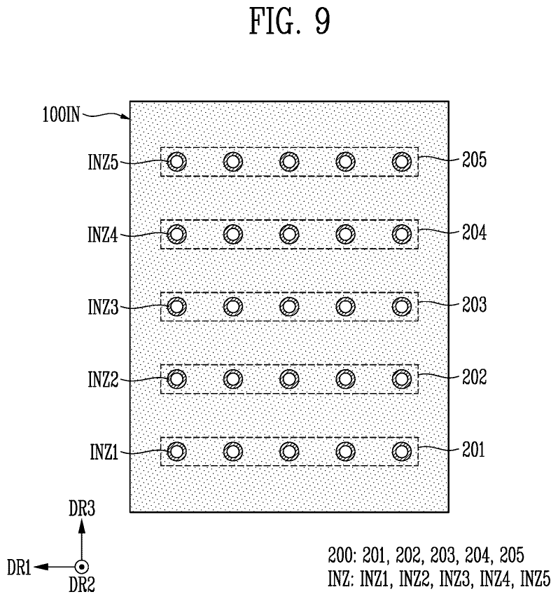

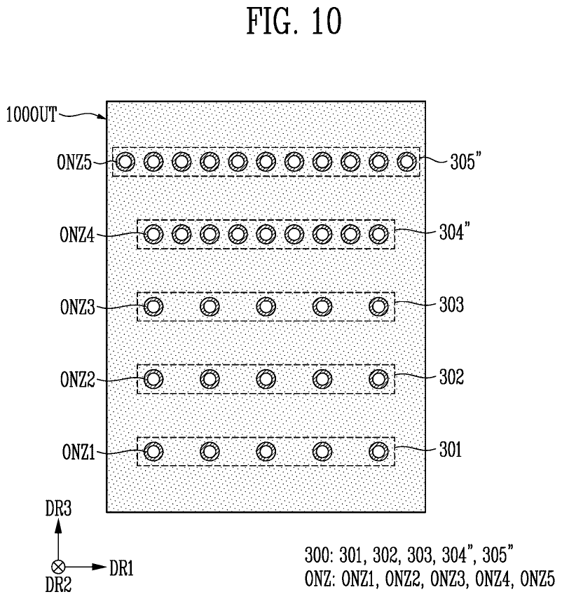

FIG. 8 illustrates a heat treatment apparatus according to an embodiment of the present disclosure. FIG. 9 illustrates a plan view of an embodiment of a plurality of injection nozzles of the heat treatment apparatus of FIG. 8. FIG. 10 illustrates a plan view of an embodiment of a plurality of discharge nozzles of the heat treatment apparatus of FIG. 8.

Referring to FIG. 8 to FIG. 10, a heat treatment apparatus 1000″ may be provided. Hereinafter, in describing the heat treatment apparatus 1000″, differences from the heat treatment apparatus 1000 described with reference to FIG. 1 to FIG. 4 will be mainly described, and any omitted description will be found in the previous description.

Compared to the heat treatment apparatus 1000, the heat treatment apparatus 1000″ may not include a plurality of additional discharge nozzles AONZ. In this case, in order to facilitate gas discharge from the upper portion of the accommodation space of the chamber 100 of the heat treatment apparatus 1000″, the number of fifth discharge nozzles ONZ5 defining the fifth discharge nozzle row 305″ disposed at the uppermost portion may be relatively large. More specifically, the number of fifth discharge nozzles ONZ5 defining the fifth discharge nozzle row 305″ disposed in the uppermost row may be greater than the number of first discharge nozzles ONZ1 defining the first discharge nozzle row 301 disposed in the lowermost row.

In the embodiment, the number of fifth discharge nozzles ONZ5 defining the fifth discharge nozzle row 305″ may be greater than the number of fifth injection nozzles INZ5 defining the fifth injection nozzle row 205.

In the embodiment, the number of fourth discharge nozzles ONZ4 defining the fourth discharge nozzle row 304″ may be relatively large. For example, the number of fourth discharge nozzles ONZ4 may be greater than the number of fourth injection nozzles INZ4 defining the fourth injection nozzle row 204. In this case, the number of fourth discharge nozzles ONZ4 may be less than the number of fifth discharge nozzles ONZ5.

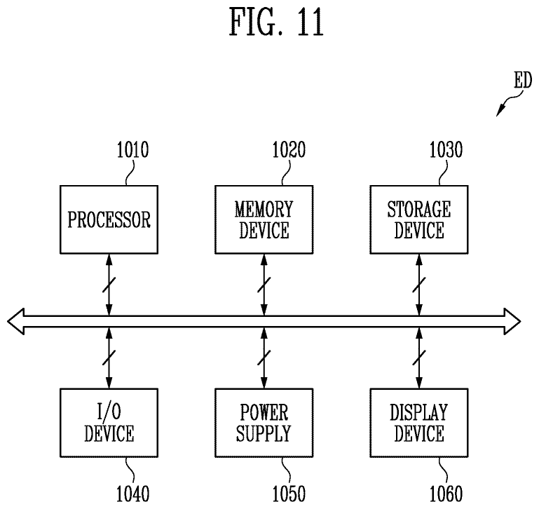

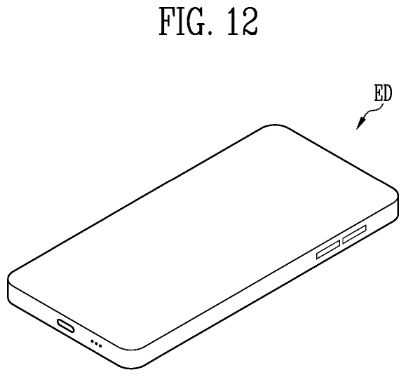

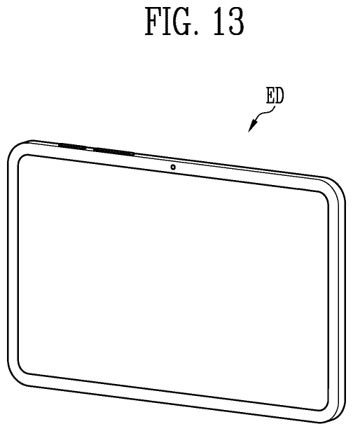

FIG. 11 illustrates a schematic block diagram of an electronic device including a display device. FIG. 12 illustrates a schematic diagram of an example where the electronic device of FIG. 11 is a smartphone. FIG. 13 illustrates a schematic diagram of an example where the electronic device of FIG. 11 is a tablet computer.

Referring to FIG. 11, FIG. 12, and FIG. 13, the electronic device ED may include a processor 1010, a memory device 1020, a storage device 1030, an input/output (I/O) device 1040, a power supply 1050, and a display device 1060. The display device 1060 may include a window, and the window may be the heat treatment object TG which is heat treated by using the heat treatment apparatus 1000, 1000′, or 1000″. The electronic device ED may further include various ports for communication with a video card, a sound card, a memory card, a USB device, or other systems. In an embodiment, as illustrated in FIG. 12, the electronic device ED may be a smartphone. In an embodiment, as illustrated in FIG. 13, the electronic device ED may be a tablet computer. However, the aforementioned examples are illustrative, and the electronic device ED is not necessarily limited to the aforementioned examples. For example, the electronic device ED may be a cellular phone, a video phone, a smart pad, a smartwatch, a navigation device for vehicles, a computer monitor, a laptop computer, a head-mounted display device, or the like.

The processor 1010 may perform specific calculations or tasks. In an embodiment, the processor 1010 may be a microprocessor, a central processing unit, an application processor, or the like. The processor 1010 may be connected to other components through an address bus, a control bus, a data bus, and the like. In an embodiment, the processor 1010 may be connected to an expansion bus such as a peripheral component interconnect (PCI) bus. In an embodiment, the processor 1010 may provide input image data to the display device 1060. Hence, the display device 1060 may display an image based on the input image data provided from the processor 1010.

The memory device 1020 may store data needed to perform the operation of the electronic device ED. The memory device 1020 may function as a working memory and/or a buffer memory for the processor 1010. For example, the memory device 1020 may include one or more volatile memory devices such as a dynamic random access memory (DRAM) device, a static random access memory (SRAM) device, and a mobile DRAM device.

The storage device 1030 may store data in response to control signals or data from the processor 1010. The storage device 1030 may include one or more non-volatile storages to retain the data even when the electronic device ED is powered off. In some embodiments, the storage device 1030 may include a solid state drive (SSD), a hard disk drive (HDD), a CD-ROM, or the like.

The I/O device 1040 may include input devices such as a keyboard, a keypad, a touchpad, a touch screen, and a mouse, and output devices such as a speaker and a printer. In an embodiment, the display device 1060 may be integrated with the I/O device 1040.

The power supply 1050 may supply power needed to perform the operation of the electronic device ED. For example, the power supply 1050 may include a power management integrated circuit (PMIC). In an embodiment, the power supply 1050 may supply power to the display device 1060.

The display device 1060 may display images in response to control signals or data from the processor 1010. The display device 1060 may be connected to other components through the buses or other communication links.

While this disclosure has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A heat treatment apparatus comprising:
a chamber including an injection surface and a discharge surface facing the injection surface and providing an accommodation space to accommodate a heat treatment object;
an injection nozzle array connected to the accommodation space through the injection surface and including a plurality of injection nozzles arranged along row and column directions;
a discharge nozzle array connected to the accommodation space through the discharge surface and including a plurality of discharge nozzles arranged along the row and column directions; and
a plurality of first additional discharge nozzles connected to the accommodation space through the discharge surface, disposed above the plurality of discharge nozzles, and arranged along the row direction,
wherein the number of the plurality of injection nozzles is less than a sum of the number of the plurality of discharge nozzles and the number of the plurality of first additional discharge nozzles.

2. The heat treatment apparatus of claim 1, wherein
the injection nozzle array includes first to N-th (N is a natural number of 3 or more) injection nozzle rows arranged along the column direction, and
the discharge nozzle array includes first to N-th discharge nozzle rows arranged along the column direction.

3. The heat treatment apparatus of claim 2, wherein
an M-th (M is a natural number of 1 or more and N or less) injection nozzle row among the first to N-th injection nozzle rows is disposed at the same height as an M-th discharge nozzle row among the first to N-th discharge nozzle rows.

4. The heat treatment apparatus of claim 2, further comprising
a plurality of second additional discharge nozzles connected to the accommodation space through the discharge surface, disposed between the N-th discharge nozzle row and the (N−1)-th discharge nozzle row, and arranged along the row direction.

5. The heat treatment apparatus of claim 1, wherein
the number of the plurality of injection nozzles is the same as the number of the plurality of discharge nozzles.

6. The heat treatment apparatus of claim 1, further comprising
a heater connected to the plurality of injection nozzles and heating an injection gas provided to the plurality of injection nozzles.

7. The heat treatment apparatus of claim 1, further comprising
a heating unit surrounding at least one of the plurality of injection nozzles, the plurality of discharge nozzles, and the plurality of first additional discharge nozzles.

8. A heat treatment apparatus comprising:
a chamber including an injection surface and a discharge surface facing the injection surface and providing an accommodation space to accommodate a heat treatment object;
an injection nozzle array connected to the accommodation space through the injection surface and including a plurality of injection nozzles arranged along row and column directions; and
a discharge nozzle array connected to the accommodation space through the discharge surface and including a plurality of discharge nozzles arranged along the row and column directions,
wherein an inner diameter of each of the discharge nozzles disposed in an uppermost row among the plurality of discharge nozzles is greater than an inner diameter of each of the discharge nozzles disposed in a lowermost row among the plurality of discharge nozzles.

9. The heat treatment apparatus of claim 8, wherein
the number of the plurality of injection nozzles is the same as the number of the plurality of discharge nozzles.

10. The heat treatment apparatus of claim 8, wherein
the injection nozzle array includes first to N-th (N is a natural number of 3 or more) injection nozzle rows arranged along the column direction, and
the discharge nozzle array includes first to N-th discharge nozzle rows arranged along the column direction.

11. The heat treatment apparatus of claim 10, wherein
an M-th (M is a natural number of 1 or more and N or less) injection nozzle row among the first to N-th injection nozzle rows is disposed at the same height as an M-th discharge nozzle row among the first to N-th discharge nozzle rows.

12. The heat treatment apparatus of claim 10, wherein
an inner diameter of each of the discharge nozzles defining the N-th discharge nozzle row is greater than an inner diameter of each of the injection nozzles defining the N-th injection nozzle row.

13. The heat treatment apparatus of claim 12, wherein
an inner diameter of each of the discharge nozzles defining the (N−1)-th discharge nozzle row is greater than an inner diameter of each of the injection nozzles defining the (N−1)-th injection nozzle row.

14. The heat treatment apparatus of claim 13, wherein
an inner diameter of each of the discharge nozzles defining the N-th discharge nozzle row is greater than an inner diameter of each of the discharge nozzles defining the (N−1)-th discharge nozzle row.

15. The heat treatment apparatus of claim 10, wherein
an inner diameter of each of the discharge nozzles defining the first discharge nozzle row is the same as an inner diameter of each of the injection nozzles defining the first injection nozzle row.

16. A heat treatment apparatus comprising:
a chamber including an injection surface and a discharge surface facing the injection surface and providing an accommodation space to accommodate a heat treatment object;
an injection nozzle array connected to the accommodation space through the injection surface and including a plurality of injection nozzles arranged along row and column directions; and
a discharge nozzle array connected to the accommodation space through the discharge surface and including a plurality of discharge nozzles arranged along the row and column directions,
wherein the number of discharge nozzles disposed in an uppermost row among the plurality of discharge nozzles is greater than the number of discharge nozzles disposed in a lowermost row among the plurality of discharge nozzles.

17. The heat treatment apparatus of claim 16, wherein
the injection nozzle array includes first to N-th (N is a natural number of 3 or more) injection nozzle rows arranged along the column direction, and
the discharge nozzle array includes first to N-th discharge nozzle rows arranged along the column direction.

18. The heat treatment apparatus of claim 17, wherein
an M-th (M is a natural number of 1 or more and N or less) injection nozzle row among the first to N-th injection nozzle rows is disposed at the same height as an M-th discharge nozzle row among the first to N-th discharge nozzle rows.

19. The heat treatment apparatus of claim 17, wherein
the number of discharge nozzles defining the N-th discharge nozzle row is greater than the number of injection nozzles defining the N-th injection nozzle row.

20. The heat treatment apparatus of claim 19, wherein
the number of discharge nozzles defining the (N−1)-th discharge nozzle row is greater than the number of injection nozzles defining the (N−1)-th injection nozzle row.

21. An electronic device comprising:
a processor to provide input image data; and
a display device to display an image based on the input image data, the display device including a window,
wherein the window is a heat treatment object which is heat treated by using the heat treatment apparatus in according to claim 1.
